(19) United States
(12) Patent Application Publication
(10) Pub. No.: US 2026/0065312 A1
(43) Pub. Date: Mar. 5, 2026

(54) METHOD TO PROMOTE INTERACTION BETWEEN ATHLETES AND SUPPORTERS

(71) Applicant: TechNlLogy Solutions, LLC, Town & Country, MO (US)

(72) Inventors: Rabeeh A. Lutfiyya, St. Charles, MO (US); Joel R. Lutfiyya, St.Charles, MO (US)

(21) Appl. No.: 19/316,834

(22) Filed: Sep. 2, 2025

Related U.S. Application Data
(60) Provisional application No. 63/689,521, filed on Aug. 30, 2024.

(51) Int. Cl. G06Q 30/0226

(52) U.S. Cl. CPC G06Q 30/0226

(57) ABSTRACT

A method to promote interaction between Student-Athlete and fans, or Supporters, has a management module that activates displays to users, and links to third party providers. The management module then opens a registration module. The registration module allows users to enter information and to participate in using the method. With users registered, the management module coordinating with the registration module activates a user experience module. This module presents the visible and financial form of the invention to the users. The experience module has many functions including displaying, paying of funds, and calculating rewards. The experience module has additional detailed functions. This invention has Student-Athletes as users and their Supporters as users.

### CROSS REFERENCE TO RELATED APPLICATION

This non-provisional application claims priority to the pending provisional application Ser. No. 63/689,521 filed on Aug. 30, 2024 and all applications have common inventors.

### BACKGROUND OF THE INVENTION

The present invention relates to software for athletes to interact with their fan base. More particularly, the present invention provides a method mesh an athlete experience with a supporter experience including video and reward systems based upon name, image, and likeness, or NIL, of athletes.

People have cheered for athletes since the Olympics of ancient Greece. Through the centuries various sports have developed. In early times, people played sports from their everyday tasks or military skills. Archery for hunting became archery for targets. Hammers saw use in shops of all kinds and became the hammer toss. Spear throwing for hunting and military use became the javelin. Jumping over walls and riding of horses lead to the high jump of track and the pommel horse of gymnastics. As people have run and swam for the eons, track and field and swimming events developed of wide description. In the last two centuries, cricket developed in India and then inspired baseball. Rugby has seen play for a similar timespan and then it inspired football. During a cold winter, a college professor put a basket to good use and thus began basketball. People's desire for play and a bit of competition has produced a wide variety of sports. People of high enthusiasm for an athlete or a team become fanatics, or fans.

In the last century, athletes developed at schools both primary and collegiate and then played on teams sponsored by the schools. That developed the concept of the Student-Athlete from the ancient maxim, a healthy mind in a healthy body, as sports promoted health and studies promoted the mind. Collegiate sports coexisted with teams also sponsored by companies, drinking establishments, towns, and others. Then youth answered the call to the First World War. That disrupted Student-Athletes for a few years but then youth returned to school, and sports. Various leaders of the academy and of sport realized students playing on professional teams compromised the amateur aspect of sports and themselves. Such students and their teams also risked the taint of gambling. Taking inspiration from Pres. Roosevelt, scholars and coaches assembled and eventually formed the National Collegiate Athletic Association, or NCAA, to regulate the rules of college sport, protect young athletes, and promote competition.

Under the NCAA, athletes, teams, leagues, conferences, and tournaments flourished. Rivalries developed and fans enjoy many an exciting game, meet, tournament, and the like. Even before the NCAA formed, select sporting events had radio and newspaper coverage. The NCAA then monitored technological developments and in time sporting events had extensive radio coverage followed by television when it arrived. Initially, the NCAA permitted television networks to host prime games and meets, heavily towards football. As the years moved along, select schools and conferences negotiated their own deals with television and other media providers. Fans nearly everywhere could catch a game. Through it all, Student-Athletes remained scholars and unpaid amateurs.

In time, television developed cable television and the internet arrived in the mid-1990s. The internet allows wide dispersal of information, including sports scores and news. The internet also permits dissemination of video like none before. Select schools and conferences benefited immensely from their media deals. And yet, the Student-Athlete remained an amateur, sometimes provided tuition at best. Once more, the internet evolved and social media entered the media scene. With social media, one person can have a blog, called a microblog, at his finger tips and inform liked mind persons, nearly at will.

Along with the Internet, electronic games of all description utilized representations of athletes. In recent years, legal developments have adjusted the amateur status of Student-Athletes, dramatically so. Rights in an athlete's name, image, and likeness have returned to the athlete at last. Building upon publicity and copyright, athletes have put their names, images, and likenesses to good use in an abundance of media ways, heavily on the internet and social media.

### DESCRIPTION OF THE PRIOR ART

From the days of the Black Sox baseball scandal to the time of Pete Rose and his troubles, money and sport have opposed each other. However, since early man first put two horses to a speed contest, people have gambled on sports. Various sports betting operations operate where permitted across the country. The country and its sports fans have become accustomed to money and sport intertwining, especially at the professional level.

Various conferences and the NCAA seek to keep the amateur nature of collegiate sports and high school sports intact. The growing use of NIL by Student-Athletes brings money closer to sports below the professional level.

Therefore, a need exists for a new and improved method to promote interaction between athletes and fans that can be used by athletes and supporters or fans to enjoy the NIL of the athletes with money properly controlled while preserving the amateur nature of sports. In this regard, the present invention substantially fulfills this need. In this respect, the method to promote interaction between athletes and fans according to the present invention substantially departs from the conventional concepts and designs of the prior art, and in doing so provides a method primarily developed for the purpose of increasing dissemination of NIL to athletes from their supporters with proper safeguards upon money.

The method to promote interaction between athletes and fans overcomes the above-mentioned disadvantages and drawbacks of the prior art. As such, the general purpose of the present invention, which will be described subsequently in greater detail, is to provide a method to promote interaction between athletes and fans which has all the advantages of the prior art mentioned heretofore and many novel features that result in long walk litter box which are not anticipated, rendered obvious, suggested, or even implied by the prior art, either alone or in any combination thereof.

### SUMMARY OF THE INVENTION

The present invention has an athlete, or Student-Athlete, portion and a fan, or Supporter, portion coordinated through a management module that produces a satisfying experience for Student-Athletes and Supporters alike while using name, image, and likeness of the athlete properly. In the dynamic landscape of college athletics, the invention emerges as a visionary force, poised to revolutionize the way everyday fans connect with and support their favorite NCAA Student-Athletes. With the advent of the Name, Image and Likeness, NIL, era, the invention recognizes the untapped potential for small-scale, direct fan engagement and support. The inventors' groundbreaking platform aims to democratize NIL funding, enabling fans to make a tangible difference in the lives of the Student-Athletes they admire.

There has thus been outlined, rather broadly, the more important features of the invention in order that the detailed description thereof that follows may be better understood and in order that the present contribution to the art may be better appreciated. Additional features of the invention will be described hereinafter, and which will form the subject matter of the claims attached. The additional features include bridging the gap between Supporters and Student-Athletes, creating a platform that facilitates direct, meaningful interactions, operating a conduit for Supporters to provide financial support to their favorite NCAA Student-Athletes, and fostering a sense of connection and investment in their success. The invention also offers innovative features, including “One Timer” payment options for instant Student-Athlete support, “Run it Back” payments for sustained backing, and unique “Stick Around” and “Fresh Start” funds designed to incentivize Student-Athlete retention and attract top talent. Harnessing the power of collective fan support, the invention redefines the landscape of NIL funding and interaction of athlete and supporter.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved method to promote interaction between athletes and fans that may allow athletes to monetize their NIL.

Another object of the present invention is to provide a new and improved method to promote interaction between athletes and fans that may be easily and efficiently developed and deployed to the consuming public.

Another object of the present invention is to provide a method to promote interaction between athletes and fans for increasing the use of NIL by athletes and the viewing of NIL by Supporters.

The Applicants' mobile application and website, for the method to promote interaction between athletes and fans, provide a comprehensive, user-friendly platform that seamlessly integrates the diverse functionalities envisioned by the Applicants. The invention's engaging and intuitive interface guides Supporters through the process of discovering, selecting, and supporting Student-Athletes. The invention features robust athlete profiles, searchable by sport, school, and position, enabling Supporters to easily connect with the Student-Athletes they wish to support. The invention is available as a mobile application on the Apple iOS and Google Android operating systems, and functions on Google Chrome, Apple Safari, Mozilla Firefox and Microsoft Edge web browsers.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In reference to the drawings,

FIG. 1 provides a block diagram of the present invention; and

FIG. 2 provides a flow chart of the present invention.

The same reference numerals refer to the same parts throughout the various figures.

### DESCRIPTION OF THE PREFERRED EMBODIMENT

A method to promote interaction between Student-Athletes and fans, or Supporters, has operational components and components visible to users. For this method, the users include Student-Athletes and their Supporters. More particularly, this method has users of Student-Athletes and Supporters at the level of a support.

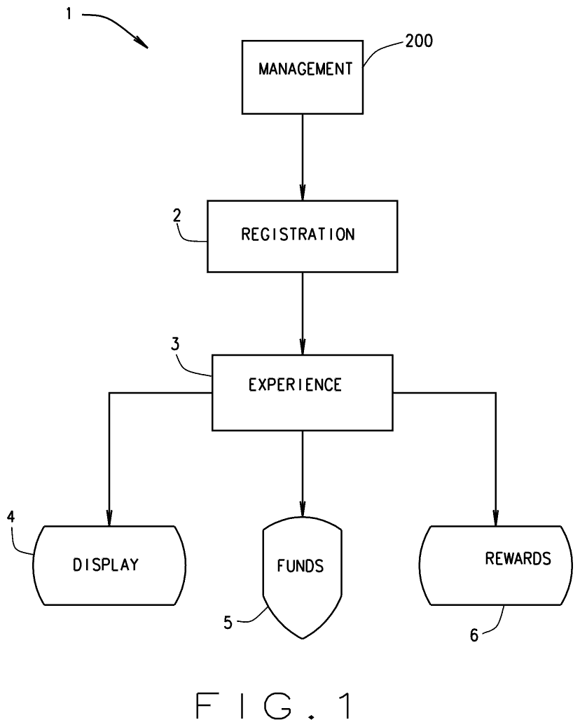

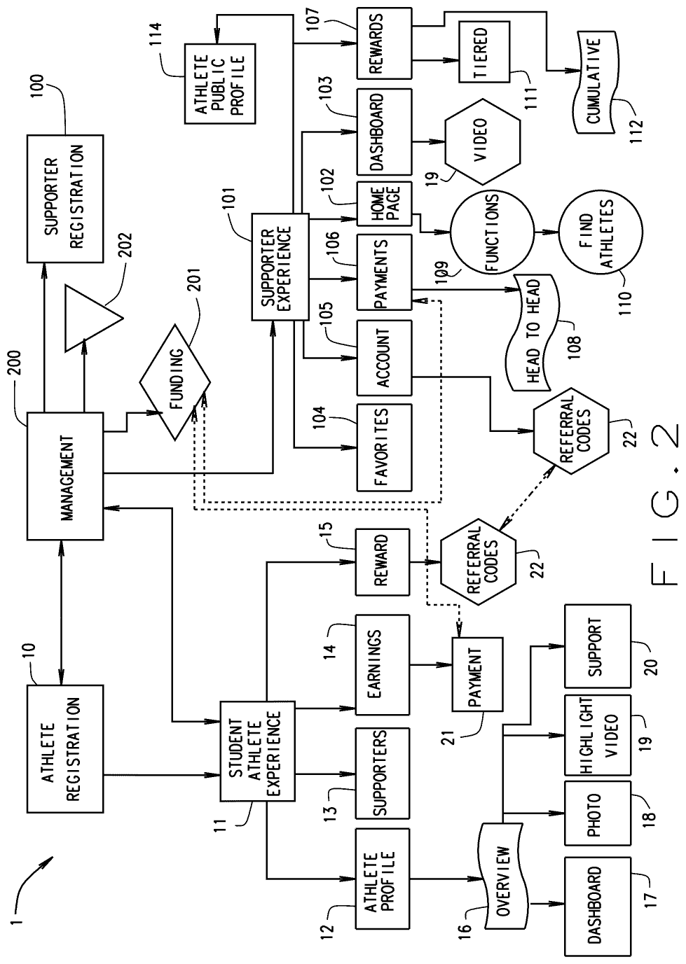

Turning to FIG. 1, the method to promote interaction between Student-Athletes and fans, as at 1, begins with a management module 200 that starts the method, activates displays to users, and maintains links to third party providers, such as payment processors, and the like. With the invention running, the management module 200 then opens a registration module as at 2. The registration module 2 allows users to enter information into the invention and to participate in using the method. The operations of the registration module 2 have further description as later shown in FIG. 2. With users registered, the management module coordinating with the registration module activates a user experience module as at 3. This module follows its name and presents the visible and financial form of the invention to the users. The experience module has many functions with this figure showing the primary functions of displaying as at 4, paying of funds as at 5, and calculating rewards as at 6. FIG. 1 shows the global arrangement of the invention, recognizing that the experience module has many functions as later shown in FIG. 2.

Let us turn then to FIG. 2 which shows the invention 1 of the method to promote interaction between Student-Athletes and fans with the Student-Athlete portion towards the left. A Student-Athlete begins use of the invention with Athlete Registration as at 10. Also, where a masculine pronoun is used, the feminine pronoun and the neuter pronoun are implied.

Participation in the invention by Student-Athletes is completely voluntary, and when a Student-Athlete decides to take advantage of the opportunity provided to him by the invention, the Student-Athlete registers through an innovative mobile application or web based process. The first step in registration for a Student-Athlete is to provide a school issued e-mail address, traditionally an e-mail address with a .edu extension, select a password, enter a referral code, if applicable, confirm that he's a United States citizen, or that he's otherwise legally eligible to earn income in the United States, and review and accept the invention's Terms of Use. Once the Student-Athlete has entered this information, he taps the “Register” button at the bottom of the page and a unique verification code is sent to the e-mail address provided.

The Student-Athlete then retrieves the unique verification code from his e-mail and proceeds as follows:
1) Enters the verification code on the app and taps the “Register” button at the bottom of the page.
2) On the next page, types his first name, last name, provides his preferred e-mail address, such as the school issued e-mail address used to obtain a verification code in the first step, and selects his preferred pronouns from a drop-down menu with the following options: “she/her/hers,” “he/him/his,” and “they/them/their”. The Student-Athlete also uploads a profile picture. Then the Student-Athlete taps the “Next” button at the bottom of the page.
3) On the next page, the Student-Athlete selects the school he attends through an intuitive interface. At the top of the page are tappable icons for a curated selection of prominent NCAA athletic conferences, and below those icons are clickable links to access all conferences in the NCAA, sorted by division (Division I, Division II, and Division III). Tappable means a user's finger briefly applied to a smartphone screen to a specify location. The process for the Student-Athlete to select his school through the intuitive menu is by first selecting either one of the prominent conference icons at the top, or one of the three divisions listed below. If one of the three divisions below is selected, the Student-Athlete then selects the conference of his school from the page generated, which lists all conferences within the division. Once the conference is selected, either from the selection of prominent conferences or after narrowing down by division, a menu of all of the schools in the conference is presented, and the Student-Athlete selects his school by tapping the icon on the page. A pop-up then appears with the school that was selected, and the Student-Athlete either confirms the school by tapping the “Confirm” button on the page, or edits the school by tapping the “Edit School” button on the page. If the Student-Athlete selects Edit School, the invention returns to the school selection page containing the curated selection of prominent conferences and divisions and selects a different school using the same process described above. If the Student-Athlete selects Confirm, he proceeds to the next registration page.
4) On the next page, the Student-Athlete:
   4a Selects his first academic year of participation from a drop-down menu. The drop-down menu will include the upcoming academic year formatted as “2024-2025 Academic Year”, and will also include years progressing retroactively to the academic year which was five years prior to the upcoming academic year (“2023-2024 Academic Year”, “2022-2023 Academic Year”, and so on). Establishment of the Student-Athlete's first academic year of participation in college sports allows the invention to determine how many years of eligibility the Student-Athlete has remaining to participate in college sports, which is necessary to determine a Student-Athlete's eligibility to participate in certain aspects of the invention platform, such as Stick Around support and Fresh Start support, and sets parameters for distribution of Fresh Start support received.
   4b Selects the sport or activity that he participates in from a drop-down menu. The drop-down menu is a comprehensive list of sports and other extra-curricular activities offered at colleges and universities, and includes an “Other” option to accommodate Student-Athletes who participate in a sport or activity not included in the list. If “Other” is selected, the Student-Athlete types the name of his sport in a pop-up that is automatically generated.
   4c Selects the position or other description of role the Student-Athlete performs for his school. The drop-down menu includes a comprehensive list of positions, based on the sport or activity selected in the previous step, and includes an “Other” option to accommodate Student-Athletes whose position is not included in the list. If “Other” is selected, the Student-Athlete types the name of his position in a pop-up that is automatically generated.
   4d Types in his jersey number worn while participating in his sport or activity, if applicable. Then the Student-Athlete taps the “Next” button at the bottom of the page.
5) On the next page, the Student-Athlete types in information that he wishes to appear in the Bio section of the Student-Athlete's profile visible to the public, referred to herein as the Student-Athlete's Public Facing Profile as at 114. This is the Student-Athlete's opportunity to tell Supporters more about himself, and may include information about the Student-Athlete's family, faith, major, career plans, hobbies, favorite video games, favorite foods, etc. Once the Student-Athlete completes his bio, he taps the “Next” button at the bottom of the page.
6) On the next page, the Student-Athlete can:
   6a Type in information about the Student-Athlete's achievements and awards, which are featured on the Student-Athlete's Public Facing Profile.
   6b Type in information about the Student-Athlete's career milestones, which are featured on the Student-Athlete's Public Facing Profile. The Student-Athlete then taps the “Next” button at the bottom of the page.
7) On the next page, the Student-Athlete types in his social media “handles” which identify him on various social media platforms, including LinkedIn, Instagram, X, Snapchat, TikTok, and Facebook. The social media handles are visible to users of the invention. Then the Student-Athlete taps the “Next” button at the bottom of the page.
8) On the next page, the Student-Athlete types in the total amount of support required for a Supporter to reach tiered reward levels, such as Silver Medal, Gold Medal, and Platinum Medal, described below, as at Process x02. The Student-Athlete then taps the “Next” button at the bottom of the page.
9) On the next page, the Student-Athlete is prompted to record his “Thank You Video.” The Thank You Video is a critical and unique part of the invention's platform. The Thank You Videos are stored on the invention's servers and delivered digitally through the application and via electronic mail to every Supporter who provides support to the Student-Athlete through the invention, satisfying the Student-Athlete's legal obligation to provide consideration for the support. The process for recording the Thank Video is that the Student-Athlete clicks on the “Record Your Thank You Video” button on the page, the invention then opens the Student-Athlete's native camera app on his mobile device and prompts him to begin recording. The Student-Athlete then records a video of himself offering gratitude for the support using his mobile device. The Student-Athlete then taps the “Next” button at the bottom of the page.
10) On the next page, the Student-Athlete is offered the opportunity to upload other photos and videos, and provide links to videos embedded on other internet sites such as ESPN.com, On3.com, Foxsports.com, CBSSports.com, 247sports.com, and huddlehuddle.com. All of the photos, videos, and links to videos appear on the Student-Athlete's Public Facing Profile. Once the Student-Athlete is done uploading photos, videos, and links to videos, he or she taps the “Finish” button at the bottom of the screen and registration is complete.

In order to ensure security and safeguard against fraud, the present invention verifies the identity of Student-Athletes using his school issued e-mail addresses, and by implementing the following process:
1. Obtain the Student-Athlete's Thank You Video as described above; and
2. Compare a still shot from the Student-Athlete's Thank You Video to a third-party online photograph of the Student-Athlete.
   Although a school issued e-mail address is necessary for identity confirmation, Student-Athletes are free to use any e-mail address for their login to the invention.

After a Student-Athlete registers, the invention uses a portion of the experience module 3 for a Student-Athlete User Experience as at 11. The Student-Athlete user experience includes multiple sections which Student-Athletes are able to fluidly navigate from a menu at the bottom of every page in the mobile app, and the top of every page of the web app, including “Profile,” “Earnings,” “Supporters,” and “Rewards.”

The Student-Athlete experience has a Student-Athlete “Profile” Page as at 12. The Student-Athlete “Profile” page includes these sections, “Dashboard” as at 17, “Overview” as at 16, “Photos” as at 18, “Highlight Videos” as at 19 and support as at 20, which are selected by using a toggle switch near the top of the page.

The “Dashboard” Page as at 17 has the following features:
1) “Payout Overview”, a section where Student-Athletes can easily see total earnings they've received from all Supporters through the platform.
2) A “View Payments and Payouts” button, which if tapped sends the Student-Athlete to his “Earnings” page (described below).
3) “Self-Promotion Verification.” A section where Student-Athletes submit a link to a required periodic social media post promoting his invention profiles. The process for a Self-Promotion Verification is:
   3a The Student-Athlete posts a social media post, on his preferred social media platform, in which they promote his invention profile;
   3b The Student-Athlete copies a link to the social media post and pastes it into the empty field under “Self-Promotion Verification” on the Student-Athlete's Dashboard page;
   3c The link is automatically sent to invention administrators;
   3d Invention administrators verify that the social media post satisfies the Student-Athletes self-promotion requirement; and
4) A “Contact Us” button, which allows the Student-Athlete to send the invention a message with any concerns or questions they may have.
The “Overview” Page as at 16 contains the following features:
16a “Bio”. A section where the Student-Athlete can view his current bio profile, and update the bio profile at the Student-Athlete's discretion;
16b “School”. A section where the Student-Athlete can view the school currently indicated on his profile, and update the school as necessary;
16c “Sport”. A section where the Student-Athlete can view the sport currently indicated on his profile, and update the sport as necessary;
16d “Position”. A section where the Student-Athlete can view the position currently indicated on his profile, and update the position as necessary;
16e “Jersey Number”. A section where the Student-Athlete can view the jersey number currently indicated on his profile, and update the jersey number as necessary;
16f “Eligibility”. A section where the Student-Athlete can view the class year profile currently indicated on his profile, and update the class year profile as necessary;
16g “Achievements & Rewards”. A section where the Student-Athlete can view the achievements and rewards currently indicated on his profile, and update the achievements and rewards as necessary;
16h “Career Milestones”. A section where the Student-Athlete can view the career milestones currently indicated on his profile, and update the career milestones as necessary;
16l “Socials”. A section where the Student-Athlete can view the social media “handles” currently indicated on his profile for LinkedIn, Instagram, X, Snapchat, TikTok, and Facebook, and update the social media “handles” as necessary;
16j “Thank You Video”. A section where the Student-Athlete can update the thank you video delivered to Supporters after each support payment by clicking on the “Record Your Thank You Video” button. The invention will then open the Student-Athlete's native camera app on his mobile device and prompt him to begin recording. Once the recording is complete, the Student-Athlete's newly recorded video message will replace his current Thank You Video;
16k An “I've Entered the Transfer Portal” toggle button indicating that the Student-Athlete has entered the transfer portal and would like to activate the “Fresh Start” support option on the Student-Athlete's Public Facing Profile. When the Student-Athlete indicates he has entered the transfer portal via the toggle button, the Student-Athlete is required to complete an additional section that appears asking him to provide the schools he's considering as possible transfer destinations. The process for the Student-Athlete to provide possible transfer destinations includes:
   16k1 Once the Student-Athlete activates the toggle button, a menu is generated below and the Student-Athlete types the name of the first school they're considering as a transfer destination;
   16k2 A list of schools whose names contain the text typed by the Student-Athlete is automatically generated, and the Student-Athlete taps on a school they're considering. The name and icon of the school then appear below the text entry field;
   16k3 The Student-Athlete can add as many schools as they like by tapping the convenient “+” button to the right of the text entry field and selecting more schools using the process described above. Each time the Student-Athlete adds a school, the name and icon of the school appear below the text entry field;
   16k4 The Student-Athlete can also remove a school that was previously selected in error by tapping the “x” button in the logo box of the school;
   16k5 When the Student-Athlete has finished adding all schools they're considering as transfer destinations, they press the “Save Changes” button at the bottom of the page, or the “Save” button at the top of the page; and
   16k6 Once the Student-Athlete taps the “Save Changes” or “Save” button, the process to verify mutual interest by the potential transfer destination school, as at Process x01, is triggered.
   Then the Student-Athlete “Photos” page as at 18 contains the following features:
   18a Displays all photos currently included in the Student-Athlete's profile, which appear in the Student-Athlete's Public Facing Profile;
   18b an “Add” button provides the Student-Athlete with the ability to upload or capture new photos to the Student-Athlete's Public Facing Profile using the following process:
   18b1 Once the Student-Athlete clicks the “Add” button, a pop-up window appears, giving the Student-Athlete the option to upload photos from his mobile device's image/video library or use his mobile device's native camera app to take a new photo;
   18b2 After each new photo is uploaded or captured, the Student-Athlete can then add comments, descriptions, and hashtags for each newly added photo; and
   18b3 Once the Student-Athlete is satisfied with the new photos, descriptions, and hashtags, the Student-Athlete taps the “Submit” button on the page and the photos are automatically added to the Student-Athlete's Public Facing Profile.
Then the Student-Athlete “Highlight Videos” page as at 19 contains the following features:
   19a Displays all videos currently included in the Student-Athlete's profile, which appear in the Student-Athlete's Public Facing Profile;
   19b An “Add” button provides the Student-Athlete with the ability to upload or capture new videos to the Student-Athlete's Public Facing Profile using the following process:
   19b1 Once the Student-Athlete clicks the “Add” button, a pop-up window appears giving the Student-Athlete the option to upload a video from his mobile device's image/video library, use his mobile device's native camera app to record a new video, or paste a video embed code from a third party provider website as in the Student-Athlete registration process;
   19b2 After the new videos are uploaded, captured or embedded, the Student-Athlete can then add comments, descriptions, and hashtags for each newly added video;
   19b3 Once the Student-Athlete is satisfied with the new videos, descriptions, and hashtags, the Student-Athlete taps the “Submit” button on the page and the videos are automatically added to the Student-Athlete's Public Facing Profile.

That brings us to the Student-Athlete “Earnings” page as at 14 that has a payments page 21 that itself includes two sections, “Received Payments” as at 21a and “Pending Payments” as at 21b. A Student-Athlete user selects them by using a toggle switch near the top of the page, which transparently shows the Student-Athlete's earnings in real time.

Turning to the “Received Payments” Page as at 21a, it contains the following features:
21a1 “Total Earnings”. A section where Student-Athletes can quickly and easily see the total earnings they've received from all Supporters;
21a2 “Support Type Earnings Breakdown”. A section where Student-Athletes can view his total earnings broken down by each support type (One-Timer, Run it Back, Stick Around, and Fresh Start);
21a3 A “Manage Payout Method” button for the Student-Athlete to quickly update his payment information;
21a4 “Payments Received”. A section displaying several support payments received from Supporters. The Student-Athlete can also view all payments received by tapping the “View All” button near the bottom of the page, giving the Student-Athlete a clear summary of all payments received. Student-Athletes can sort payments by payment type (One-Timer, Run it Back, Stick Around, or Fresh Start), and secondarily by date received, Supporter name, and amount.

That then brings us to the “Pending Payments” Page as at 21b, and it contains the following features:
21b1 “Total Amount Pending”. A section where Student-Athletes can quickly and easily see the total amount of pending payments they're scheduled to receive from all Supporters;
21b2 “Manage Payout Method” button for the Student-Athlete to quickly update his payment information;
21b3 “Pending Payments”. A section with an itemized list of several pending support payments scheduled to be received from Supporters. Student-Athletes can sort his pending payments by Supporter name, amount, or date. A Student-Athlete can also view all pending payments by tapping the “View All” button near the bottom of the page, giving the Student-Athlete a clear summary of all pending payments.

Moving along FIG. 2, it takes us to the Student-Athlete “Supporters” Page as at
13 that contains the following features:
13a “Top Supporters”. A section with a list of the Student-Athlete's top 10 Supporters ranked from top to bottom based on the total amount of total support paid to the Student-Athlete;
13b A “Send A Video to Top 10 Supporters” button for the Student-Athlete to automatically select his top 10 Supporters and send them an exclusive video message using the following process:
   13b1 Once the Student-Athlete clicks the button, they're taken to a new page giving the Student-Athlete the option to upload a video from his mobile device's image/video library or use his mobile device's native camera app to record a new video.
   13b2 After the new video is uploaded or captured, the Student-Athlete then clicks the “Send Video” button on the page and the top 10 Supporters are automatically notified in-app and by e-mail that the video is available to watch within the invention app.
13c A “Send a Video to All Supporters” button for the Student-Athlete to automatically send all Supporters an exclusive video message using the following process:
   13c1 Once the Student-Athlete clicks the button, they're taken to a new page giving the Student-Athlete the option to upload a video from his mobile device's image/video library or use his mobile device's native camera app to record a new video;
   13c2 After the new video is uploaded or captured, the Student-Athlete then clicks the “Send Video” button on the page and all Supporters of the Student-Athlete are automatically notified in-app and by e-mail that the video is available to watch within the invention app.
13d A “Select Supporters to Send a Video To” button for the Student-Athlete to select specific Supporters they'd like to send an exclusive video message using the following process:
   13d1 Once the Student-Athlete clicks the button, they're taken to a new page where they see a list of all Supporters who have sent him a support payment. The Student-Athlete may sort the list by amount, support type, and date;
   13d2 The Student-Athlete chooses the Supporters they'd like to send the exclusive video to by tapping on the Supporters' profiles in the list;
   13d3 After the Student-Athlete has selected the Supporters they want to send the video to, the Student-Athlete click the “Complete Selection” button and is then taken to a new page giving the Student-Athlete the option to upload a video from his mobile device's image/video library, or use his mobile device's native camera app to record a new video;
   13d4 After the new video is uploaded or captured, the Student-Athlete then clicks the “Send Video” button on the page and only selected Supporters chosen by the Student-Athlete in previous step are automatically notified in-app and by e-mail that the video is available to watch within the invention.

FIG. 2 then illustrates a Student-Athlete “Rewards” page, as at 15, contains the following features:
15a A “See How Rewards Work” button which opens a pop-up window explaining the rewards program to Student-Athletes, informing them that they will fulfill specific rewards based on accrued support payments from Supporters;
15b A “Silver Medal” button takes the Student-Athlete to a new page where the Student-Athlete can modify the minimum support amount required for a Supporter to earn a Silver Medal, and receive a Personalized Thank You Video, as at Process x06.
15c A “Gold Medal” button takes the Student-Athlete to a new page where the Student-Athlete can modify the minimum support amount required for a Supporter to earn a Gold Medal, and receive a Social Media Shoutout, as at Process x07.
15d A “Platinum Medal” button takes the Student-Athlete to a new page where the Student-Athlete can modify the minimum support amount required for a Supporter to earn a Platinum Medal, and receive a Personalized Autographed Memorabilia Item, using the process described below as at Process x08.
15e “Rewards Fulfillment”. A section where Student-Athletes can quickly and easily view “Tiered Rewards” that have not yet been fulfilled. The Student-Athlete can click on each reward to fulfill them using as at Process x03 for Silver Medal/Personalized Thank You Video, as at Process x04 for Gold Medal/Social Media Shoutout, and as at Process x05 for Platinum Medal/Personalized Autographed Memorabilia Item.

Having described the Student-Athlete experience 11 above, the invention 1 has its management module 200 that communicates between the Student-Athlete users and the Supporter users. The management module also allows an operator of the invention to troubleshoot errors in the invention's usage. The management module also produces a set of reports, as at 202, useful to the operator of the invention. Such reports include among other things, run time of the invention without an error, number of Student-Athlete users and number of Supporter users, a registry of all users, status of funds maintained by the invention, Supporter wallet balances, rewards fulfillment tracking, and communications with third party providers. The reports function displays to authorized operators of the invention, generally a limited number of persons.

Having described the Student-Athlete registration 10 and Student-Athlete experience 11, and the management module 200, and its reporting as at 202, the invention has its Supporter side as suggested above. Akin to the Student-Athletes, Supporters begin their use of the invention with registration as at 100.

Supporters may make a one-time support payment to a Student-Athlete without registering for an account on the invention, or they can create an account through the invention's innovative mobile application or web based process. The first step in registration as a Supporter, as at 100a, is to provide an e-mail address, select a password, enter a referral code as at 22, if applicable, and review and accept the invention's Terms of Use. Once the Supporter has entered this information, he taps the “Register” button at the bottom of the page and a unique verification code is sent to the e-mail address provided.

The Supporter then retrieves the unique verification code from his e-mail and proceeds as at 100b. The Supporter 1) enters the verification code on the app and taps the “Register” button at the bottom of the page; 2) On the next page, types his first name, last name, preferred Username, that is, the name visible to other users of the invention, and optionally a phone number, then the Supporter taps the “Next” button at the bottom of the page; and 3) On the next page, types his street address, city, state, and zip code for delivery of physical rewards.

Following those three steps, 4) On the next page, the Supporter can select his favorite schools through an intuitive interface, or can continue without selecting any favorite schools by tapping the “Continue without selecting favorite school” button at the bottom of the page. At the top of the page are tappable icons for a curated selection of prominent NCAA athletic conferences, and below those icons are clickable links to access all conferences in the NCAA, sorted by division (Division I, Division II, and Division III). The process for the Supporter to select his favorite schools through the intuitive menu is by 1) first selecting either one of the prominent conference icons at the top, or one of the three divisions listed below. If one of the three divisions below is selected, the Supporter then selects the conference of the school from the page automatically generated, which lists all conferences within the division. Once the conference is selected, either from the selection of prominent conferences or after narrowing down by division, a menu of all schools in the conference is presented, and the Supporter 2) selects his favorite school by tapping the corresponding icon on the page. A pop-up then appears with the school that was selected, and other schools that the Supporter has designated as his favorite schools, and the Supporter has the options of: 1) Deleting any of the displayed schools selected by tapping the “x” next to the school name; 2) Adding more schools by tapping the “Add More Schools” button on the pop-up, in which case the Supporter is returned to the selection page containing the curated selection of prominent conferences and list of three divisions, and the Supporter selects an additional school using the process described above; or 3) Completes registration by tapping the “Finish” button on the pop-up. Once the Supporter completes registration, he next proceeds to the Supporter Home page 102.

Following registration as at 100, the Supporter then moves to the Supporter User Experience as at 101. The Supporter user experience includes multiple sections where Supporters fluidly navigate from a menu at the bottom of every page in the mobile app, and the top of every page of the web app, including “Home” 102, “Rewards” 107, “Favorites” 104, “Payments” 106, “Account” 105, and “Athlete Public Profile” 114. Let's begin with the Supporter “Home” Page at 102. The Supporter “Home” page includes two sections, “Find Athletes” as at 110 and “My Dashboard” as at 103, which are selected by using a toggle switch near the top of the page.

The “Find Athletes” Page 110 has these search Functions with the following features: 1) A typeable search bar, by which Supporters are able to easily search for schools, particular sports at particular schools (i.e.. “North Carolina Basketball”), and Student-Athlete names;
2) “My Favorite Athletes”: A section containing a list, including profile pictures, of Student-Athletes whom the Supporter has designated as his favorites. One row of favorite Student-Athletes is displayed on the Find Athletes page, and there is a link provided which if tapped takes the Supporter to the “Favorites” page as described below;
3) “My Favorite Schools”: A section where Supporters can easily find and select the schools which they've designated as his favorites. One row of favorite schools is displayed on the Find Athletes page, and there is a link provided which if tapped takes the Supporter to his “Favorites” page as described below;
4) “Find Athletes by Conference”: A section where Supporters can locate Student-Athletes they'd like to support by conference, school, and sport. Included on the Supporter's Home page are tappable icons for a curated selection of prominent NCAA athletic conferences, and another button, “View All Conferences.” The process for finding a Student-Athlete to support through this function includes: A Select a conference from the tappable icons for prominent conferences, or selecting “View All Conferences.” If the “View All Conferences” option is selected, the Supporter is taken to a page that lists the same prominent conferences at the top, and below that, buttons to narrow down the selection by division (Division I, Division II, and Division III). The Supporter then selects one of the conferences listed on this page, or one of the divisions, by tapping on the corresponding button. If a division is selected, the Supporter is taken to a new screen containing icons for all conferences within that division and selects one of those conferences. Once the Supporter has selected a conference, either from the conferences listed at the top of the page or after narrowing down by division, a menu of all schools in the selected conference is generated and the Supporter then taps on the icon for the school of the Student-Athlete that the Supporter desires to support.

B Once a school is selected, the Supporter is taken to a page displaying all sports at the school which has Student-Athletes participating in the invention. For each sport, some Student-Athlete profile pictures are displayed, and there is a link to another screen which lists all Student-Athletes in the selected sport, along with the Student-Athletes' profile pictures. The Supporter selects the Student-Athlete whom the Supporter wishes to support by tapping on the Student-Athlete's name or profile picture on the screen.
5) A “Trending Athletes” section, which contains profile pictures and names of platform wide trending Student-Athletes, scrollable to the right on the screen, showing up to ten Student-Athletes. For purposes of this section, Trending Athletes are the Student-Athletes who have received the highest number of support payments in the most recent 24 hour period, and are updated automatically by the invention's software. 6) A “Head-to-Head Matchups” button. When a Supporter taps the Head-to-Head Matchups button, they're taken to a page containing the current Head-to-Head Matchups offered on the invention platform. Beneath the Head-to-Head Matchup button on the screen are Head-to-Head Matchups offered on the invention platform involving schools which the Supporter has identified as favorites, and schools of which a Supporter has supported one or more Student-Athletes in the past.
7) A “Find Athletes Considering a Transfer to Your School” button. When a Supporter taps the Find Athletes Considering a Transfer to Your School” button, he navigates to a page that lists tappable icons for a curated selection of prominent NCAA athletic conferences, and below that, buttons to narrow down the selection by division (Division I, Division II, and Division III). The Supporter then selects one of the listed conferences from this page, or one of the divisions, by tapping on the corresponding button. If a division is selected, the Supporter is taken to a new screen containing icons for all conferences within that division and selects one of those conferences. Once the Supporter has selected a conference, either from prominent conferences at the top of the page or after narrowing down by division, a menu of all schools in the selected conference is generated. The Supporter then taps on the icon of the school of choice and is navigated to a page featuring profiles of all Student-Athletes currently in the transfer portal who have expressed an interest in the Supporter's chosen school as a transfer destination. From this menu of Student-Athlete profiles, the Supporter can effortlessly identify and elect the desired Student-Athlete they wish to support by clicking on the corresponding profile link, which takes the Supporter to the Support page of the Student-Athlete's Public Facing Profile. The Supporter then proceeds with offering Fresh Start support as described below.

Once the Supporter locates a Student-Athlete to support using any of the search options described above, the Supporter taps on the Student-Athlete's name or profile picture on the screen, which takes the Supporter to the Student-Athlete's Supporter Facing Profile 114. The Student-Athlete's Public Facing Profile 114 includes “Support” 13, “Overview” 16, “Photos” 18, and “Videos” 19 sections. Let's review those sections.

The “Support” page 13 of a Student-Athlete's Public Facing Profile 114 contains the following information:
13a The amount of support necessary for the Supporter to earn a tiered reward such as Silver Medal, Gold Medal, or Platinum Medal, as described below. If the Supporter has previously supported the Student-Athlete, then such amount of support necessary is reduced by the sum of the previous support (see Tracking below), and the Supporter's progress towards the tiered reward is demonstrated on a progress bar.
13b Ways to Support (One-Time, Run it Back, Stick Around and when a Student-Athlete has entered the transfer portal, Fresh Start) as described below.
13c A “Find Other Athletes to Support” button, which if selected by the Supporter, takes the Supporter to the Home page where the Supporter can search for other Student-Athletes to support using the search functionality described above.
13d A “Send Your Support Now” button, which sends the Supporter to a confirmation screen and payment processing.
13e A “Report Athlete” button at the bottom of the page which if tapped, can be used by the Supporter to report concerns such as fraud and inappropriate content.

Then we go back to the “Overview” page 16 of a Student-Athlete's Public Facing Profile 114. The Overview page 16 contains the following information provided by the Student-Athlete, either during the Student-Athlete's initial registration, or as updated later: biography, school attended, sport played or activity participated in, position played (if applicable), jersey number (if applicable), achievements, awards, career milestones, and links to the Student-Athlete's social media accounts. The Overview page also has its “Report Athlete” button at the bottom of the page which if tapped, can be used by the Supporter to report concerns such as fraud and inappropriate content.

The “Photos” page 18 of a Student-Athlete's Public Facing Profile 114 contains photographs uploaded by the Student-Athlete, either during the Student-Athlete's initial registration, or as updated by the Student-Athlete.

Then the “Videos” page 19 of a Student-Athlete's Public Facing Profile 114 contains videos uploaded by the Student-Athlete, or links to videos embedded on other internet sites, provided either during the Student-Athlete's initial registration, or as updated by the Student-Athlete.

Following this reminder of Student-Athlete functions, let us return to the description of the Supporter experience 101 with a “My Dashboard” Page as at 103.

The Supporter My Dashboard page 103 has contains the following features:
1) “My Favorite Athletes”: containing a list, including profile pictures, of Student-Athletes whom the Supporter has designated as his favorites. Up to two rows of favorite Student-Athletes are displayed on the My Dashboard page, and there is a link provided which if tapped takes the Supporter to a different page containing a list of all of his favorite Student-Athletes.
2) “Number of Athletes Supported”: where a Supporter can see a broad overview of the number of Student-Athletes the Supporter has supported in the current month, as well as the number of Student-Athletes the Supporter has supported overall.

From this section, the Supporter can also tap on a “Payment History” link, which takes the Supporter to the “Payments” page.
3) “Wallet”: where the Supporter can see how much funds the Supporter has available in his account to use for support of Student-Athletes. From this section, the Supporter can also tap on an “Add More Funds” button, which takes him to his “Account” page, where he can manage payment methods and add funds to his wallet, and
4) “Rewards Earned”: that displays some of the rewards that the Supporter has earned. From this section, the Supporter can also tap on a “View Rewards” button, which takes him to his Supporter's “Rewards” page.

Next let us turn to the Supporter “Rewards” Page at 107. The Supporter “Rewards” page includes these features:
1) An “Update Rewards Shipping Address” button: If the Supporter taps on the button, the Supporter is taken to the “Account” page where he can manage his shipping addresses for rewards.
2) A “Bronze Medal” section: The Bronze Medal section quickly shows the Supporter how many Bronze Medals the Supporter has earned, and includes miniaturized profile pictures of some of the supported Student-Athletes. If the Supporter taps on this section, he proceeds to a page listing all of the Student-Athletes for whom the Supporter has earned a Bronze Medal, and each such Student-Athletes' profile picture, name and school appear. Also included for each Student-Athlete listed is the amount of support necessary for the Supporter to earn a Silver Medal with regard to the particular Student-Athlete, with a progress bar, and a “Support Now” button, which the Supporter can tap. If the “Support Now” button is tapped, the Supporter is taken to the selected Student-Athlete's Public Facing Profile and the Supporter can further support the Student-Athlete.
3) A “Silver Medal” section: The Silver Medal section quickly shows the Supporter how many Silver Medals the Supporter has earned, and includes miniaturized profile pictures of some of the supported Student-Athletes. If the Supporter taps on this section, he proceeds to a page listing all of the Student-Athletes for whom the Supporter has earned a Silver Medal, and each such Student-Athletes' profile picture, name and school appear. Also included for each Student-Athlete listed is the amount of additional support necessary for the Supporter to earn a Gold Medal with regard to the particular Student-Athlete, with a progress bar, and a “Support Now” button, which the Supporter can tap. If the “Support Now” button is tapped, the Supporter is taken to the selected Student-Athlete's Public Facing Profile and the Supporter can further support the Student-Athlete.
4) A “Gold Medal” section: The Gold Medal section quickly shows the Supporter how many Gold Medals the Supporter has earned, and includes miniaturized profile pictures of some of the supported Student-Athletes. If the Supporter taps on this section, he proceeds to a page listing all of the Student-Athletes for whom the Supporter has earned a Gold Medal, and each such Student-Athletes' profile picture, name and school appear. Also included for each Student-Athlete listed is the amount of additional support necessary for the Supporter to earn a Platinum Medal with regard to the particular Student-Athlete, with a progress bar, and a “Support Now” button, which the Supporter can tap. If the “Support Now” button is tapped, the Supporter is taken to the selected Student-Athlete's Public Facing Profile and the Supporter can further support the Student-Athlete.
5) A “Platinum Medal” section: The Platinum Medal section quickly shows the Supporter how many Platinum Medals the Supporter has earned, and includes miniaturized profile pictures of some of the supported Student-Athletes. If the Supporter taps on this section, he proceeds to a page listing all of the Student-Athletes for whom the Supporter has earned a Platinum Medal, and each such Student-Athletes' profile picture, name and school appear. Also included for each Student-Athlete listed is a “Support Now” button, which the Supporter can tap. If the “Support Now” button is tapped, the Supporter is taken to the selected Student-Athlete's Public Facing Profile and the Supporter can further support the Student-Athlete.
6) A “Rewards Earned” section. The Rewards Earned section displays the rewards that the Supporter has earned. For each such reward which is digital, a button is provided which if tapped, displays the digital reward, such as Thank You Video, Personalized Thank You Video, or Social Media Shoutout, to the Supporter. The rewards are sortable by reward type such as Thank You Video 19, Personalized Thank You Video, Social Media Shoutout, and Personalized Autographed Memorabilia, date (oldest to newest, or newest to oldest), and alphabetically. To sort the rewards, the Supporter simply taps the “Sort by” button in the section and selects one of the options from a drop-down menu.

Writing of rewards then calls to mind favorites as fortune often follows them. The Supporter experience also has a Supporter “Favorites” Page as at 104. The Supporter “Favorites” page 104 includes two sections: “Favorite Athletes” and “Favorite Schools”, which are selected by using a toggle switch near the top of the page.
1) “Favorite Athletes” page lists all Student-Athletes whom the Supporter has designated as his favorites, and includes profile pictures of each such Student-Athlete.

Also included for each Student-Athlete listed is the amount of additional support necessary for the Supporter to achieve the next reward level with regard to the particular Student-Athlete, with a progress bar, and a “Support Now” button, which the Supporter can tap. If the “Support Now” button is tapped, the Supporter is taken to the selected Student-Athlete's Public Facing Profile and the Supporter can further support the Student-Athlete. The Favorite Athletes are sortable by most recent support, support type (One-Timer, Run it Back, Stick Around or Fresh Start), closest (least amount of additional support necessary) to earning next level of tiered rewards, alphabetically, or the Student-Athlete's school. To sort the Favorite Athletes, the Supporter simply taps the “Sort by” button in the section and selects one of the options from a drop-down menu. The Supporter can also remove a Student-Athlete from his favorites by tapping the star icon next to the Student-Athlete's profile picture.
2) “Favorite Schools” page lists all of the schools which the Supporter has designated as his favorites. From the “Favorite Schools” schools page, the Supporter can remove his favorites by tapping an “x” located next to the school on the page. The Supporter can also add to his list of favorite schools by tapping on the “Add Schools” button below his previously designated favorites on the page. Once the “Add Schools” button is selected, the Supporter proceeds to a page displaying tappable icons for a curated selection of prominent NCAA athletic conferences, and below those icons are clickable links to access all conferences in the NCAA, sorted by division (Division I, Division II, and Division III). The process for the Supporter to add favorite schools through the intuitive menu is by first selecting either one of the prominent conferences or one of the three divisions listed below by tapping on the selection. If one of the three divisions below is selected, the Supporter then selects the conference of the school from the page automatically generated, which lists all conferences within the division.

Once the conference is selected, either from the prominent conferences at the top of the page or after narrowing down by division, a menu of all schools in the conference is presented, and the Supporter selects his favorite school by tapping the corresponding icon on the page. A pop-up then appears with the school that was selected, and other schools that the Supporter has designated as his favorite schools, and the Supporter has the options of: 1) Deleting any of the displayed schools selected by tapping the “x” next to the school name; or 2) Adding more schools by tapping the “Add More Schools” button on the pop-up, in which case the Supporter is returned to the selection page containing the prominent conference icons and list of three divisions, and the Supporter selects an additional school using the process described above. Once the Supporter has added or removed his favorite schools, he taps the “Finish” button on the pop-up and his changes are saved.

The Supporter experience 101 also involves funding related to name, image, and likeness of a Student-Athlete. The Supporter “Payments” Page 106 interfaces with the funding module 201. The Supporter “Payments” page includes two sections: “Pending Payments” and “Payment History,” which are selected by using a toggle switch near the top of the page. Let's turn to the pair.
1) The “Pending Payments” page lists several active recurring support payments, called “Run it Back” support, including the name of the supported Student-Athlete, the amount of the pending payment, and the next scheduled payment date.

The Supporter can also view all pending payments by tapping the “View All” button near the bottom of the page, giving the Supporter a clear summary of all future support payments that the Supporter has already committed to. The list is sortable alphabetically (by Student-Athlete name), amount of next payment, and date of next payment. From the list of pending payments, the Supporter can modify or cancel any future pending payments using the following process:
1. Tap on a pending payment for any Student-Athlete. Upon doing so, the Supporter is taken to the Student-Athlete's Public Facing Profile; 2. The Run it Back payments previously pledged to the Student-Athlete are displayed on the Support page of the Student-Athlete's Public Facing Profile. At the bottom of the Run it Back section on the page is a “View Details or Edit Payment” button. The Supporter taps the “View Details or Edit Payment” button; 3. Upon tapping the “View Details or Edit Payment” button, a pop-up screen automatically generates which demonstrates the details of the current Run it Back plan. The Supporter can either modify the Run it Back support by entering a different amount, changing the frequency of payments, and/or changing the duration of payments. Under the details of the current Run it Back plan is a “Cancel Future Support” button. If the Supporter taps the “Cancel Future Support” button, a pop-up is automatically generated advising the Supporter that they're about to cancel future support. The Supporter then taps either the “Confirm” button on the pop-up, in which case the future support is cancelled, or the “Cancel” button, in which case the Supporter is returned to the Student-Athlete's Public Facing Profile. 2) “Payment History” page lists several completed support payments and includes information such as the profile picture of the Student-Athlete supported, the type of support payment (One-Timer, Run it Back, Stick Around or Fresh Start), the date of the support payment, and the amount of the support payment. The Supporter can also view all completed support payments by tapping the “View All” button near the bottom of the page, giving the Supporter a clear summary of all completed support payments. The list is sortable alphabetically (by Student-Athlete name), date, and type of support payment.

The Supporter experience has various functions described above. Those functions use common information coordinated through a Supporter “Account” Page as at 105. The Supporter “Account” page includes the Supporter's account information from initial registration, or as updated by the Supporter. The information includes the Supporter's first name, last name, preferred username, e-mail address, telephone number, password, the Supporter's unique referral code (if applicable), along with the ability to share the referral code 22 via text message or e-mail, addresses, payment methods, notification preferences (i.e.. new athlete joined, athlete milestone achieved, fund updates, personalized video unlocked, and preferred notification method), and privacy and security settings. The Supporter's information can be updated at any time from his “Account” page. The Supporter's Account page also displays the Supporter's wallet balance, funds which the Supporter has deposited and are readily available within the invention platform to use for support of Student-Athletes.

“Athlete Public Profile” 114 appears visible to Supporters and to the public. The Student Athlete loads data into his profile as at 12 described above.

The management module also includes a funding module 201. The funding module communicates to the Student-Athlete users, the Supporter users, third party payment providers, and the operator about money generated by the invention. Let us turn to more detail about the module 201.

The funding module 201 presents a variety of options to select users. The search and browsing features described below assist Supporters discover and connect with Student-Athletes he would like to support. Once a Supporter finds a Student-Athlete to support and lands on the Support page of the Student-Athlete's Public Facing Profile, the Supporter has four support options provided through the funding module.

The One-Timer where a Supporter makes a one-time payment to the Student-Athlete. The process for a Supporter to make a One-Timer support payment includes: 1) Tap on the field with the “$” in the One-Timer section of the page; 2) Enter an amount using the automatically generated keypad on the Supporter's screen; and 3) Proceed with payment by applying funds from the Supporter's wallet, or entering payment information, using the invention's secure web payment system, and tap the “Support Now” button.

Run it Back where a Supporter makes recurring payments to the Student-Athlete.

The Supporter determines the amount, frequency and duration of the support payment.

The process for a Supporter to make Run it Back support payments then has 1) Tap on the field with the “$” in the Run it Back section of the page; 2) Enter an amount using the automatically generated keypad on the Supporter's screen; 3) Tap on the “Frequency” button and select one of the options on the automatically generated drop-down menu: weekly, bi-weekly, or monthly; 4) Tap on the “Duration” button and, from the drop-down menu, select a period (from one to twelve months) that the Supporter desires to offer the Support for; and 5) On an automatically generated confirmation screen, enter payment information through the invention's secure web payment system and tap the “Support Now” button.

Stick Around where a support payment becomes contingent on the Student-Athlete returning to his school the next academic year and sport's season. The process for a Supporter to make a Stick Around support payment involves 1) Tap on the field with the “$” in the Stick Around section of the page; 2) Enter an amount using the automatically generated keypad on the Supporter's screen; and 3) Proceed with payment by applying funds from the Supporter's wallet, or entering payment information, using the invention's secure web payment system, and tap the “Support Now” button.

Fresh Start that remains dormant until the Student-Athlete has publicly declared that he may transfer to a different school. When the Student-Athlete declares that he may transfer to a different school, which is typically done by entering the NCAA transfer portal, the Student-Athlete can update his status on the invention and indicate which schools he are considering as a transfer destination. Using as at Process x01, the invention automatically sends the schools selected by the Student-Athlete as possible transfer destinations e-mails to confirm his mutual interest in accepting the Student-Athlete as a transfer, and provide the schools a specified duration to declare that the school is not interested in accepting the Student-Athlete as a transfer. If the school affirms interest in accepting the Student-Athlete as a transfer, or fails to notify the invention of its lack of interest in accepting the Student-Athlete as a transfer within the specified time, then the school will appear as a possible transfer destination for the Student-Athlete on the invention.

The processes for a Supporter to make a Fresh Start support payment are:
1) Locate the profile of a Student-Athlete that the Supporter is interested in offering Fresh Start support to. Location of a Student-Athlete may occur through:
a) The invention notifies, in app and via e-mail, Supporters who have indicated that a school being considered as a transfer destination is one of his favorites (as indicated during Supporter registration, or later added on the Supporter's Favorites page), and Supporters of one or more Student-Athletes at a school, when a Student-Athlete has listed that school as a possible transfer destination. From the Notification, the Supporter simply taps a button and is taken to the Support page of the Student-Athlete's Public Facing Profile. The Supporter then proceeds as described in Step 2, below.
b) If the Supporter has already identified a Student-Athlete to whom the Supporter wants to offer Fresh Start support, the Supporter can locate the Student-Athlete's profile by navigating to the Find Athletes section of the Supporter's Home page, and using any of the search functionalities of the invention which are part of the Supporter experience. Once the Supporter finds the Student-Athlete's profile, he tap it and are taken to the Student-Athlete's Public Facing Profile. The Supporter then proceeds as described in Step 2, below.
c) From the Supporter's “Find Athletes” section of the Supporter's Home page, the Supporter taps the “Find Athletes Considering a Transfer to Your School” button The Supporter then is navigated to a page with tappable icons for a curated selection of prominent NCAA athletic conferences, and below those icons are clickable links to access all conferences in the NCAA, sorted by division (Division I, Division II, and Division III). The Supporter then selects one of prominent conferences, or one of the divisions, by tapping on the corresponding button. If a division is selected, the Supporter is taken to a new screen containing icons for all conferences within that division and selects one of those conferences. Once the Supporter has selected a conference, either from the prominent conferences provided at the top of the page or after narrowing down by division, a menu of all schools in the selected conference is generated. The Supporter then taps on the icon of the school of choice and is navigated to a page featuring profiles of all Student-Athletes currently in the transfer portal who have expressed an interest in the Supporter's chosen school as a transfer destination. From this menu of Student-Athlete profiles, the Supporter can effortlessly identify and select the desired Student-Athlete he wish to support by clicking on the corresponding profile link, which takes the Supporter to the Support page of the Student-Athlete's Public Facing Profile. The Supporter then proceeds as described in Step 2, below.

Having located a Student-Athlete to support as in step 1), making a Fresh Start support payment continues with its step 2) as the Supporter, utilizing one of the methods described above, is now on the Support page of the Student-Athlete's Public Facing Profile of the Student-Athlete he want to support. Because the Student-Athlete has entered the transfer portal, the Support page of the Student-Athlete's Public Facing Profile now contains a “Fresh Start” section which includes a drop-down menu containing all of the schools being considered by the Student-Athlete as a transfer destination, a data entry field containing a “$”, a “Pay Now” button, and a bar graph demonstrating the total Fresh Start support offered by Supporters of each school being considered by the Student-Athlete, in real time. The process for the Supporter to complete his Fresh Start support payment is as follows:
2): a) Select the school the Supporter would like the Student-Athlete to transfer to from the drop-down menu; b) tap on the field with the “$” in the Fresh Start section of the page; c) Enter an amount using the automatically generated keypad on the Supporter's screen; and d) Proceed with payment by applying funds from the Supporter's wallet, or entering payment information, using the invention's secure web payment system, and tap the “Support Now” button.

The funding module 201 also includes Payment Processing for Supporters and Student-Athletes. The payment is processed and the funds are placed in one of four bank accounts maintained by the invention's administrators: one for each support type: One-Timer, Run it Back, Stick Around and Fresh Start. That is, account of deposit depends on the support type or types made by the Supporter.

Once a Supporter makes a support payment, the Supporter immediately receives in-app and e-mail notifications, confirming the details of the transaction. The Supporter, following support of every Student-Athlete, immediately receives the Student-Athlete's Thank You Video via in-app notification, as well as an e-mail containing a link to the gated Thank You Video as at 19a. This continues until the Supporter has reached a higher tiered reward for the particular Student-Athlete. The immediate delivery of the thank you video occurs by an automated process of the invention. The automated process prompts the Student Athlete to record a Thank You Video 19a then and there on the spot and the Supporter hears from the Student Athlete in near real time.

Student-Athletes, via mobile app notification and e-mail, receive immediate notice when a Supporter has submitted a support payment, and of the amount, type (One-Timer, Run it Back, Stick Around, or Fresh Start), frequency, and duration of the support in the case of Run it Back support, as well as the user name of the Supporter who contributed the support. Via the app and web site, Student-Athletes then may track all of his support in real time, viewing all of the funds he has received in the past, and all of the support anticipated to be received in the future, based on support transactions.

Through the invention, the funds due to each Student-Athlete, after deduction for invention operating costs, are automatically disbursed at a specified time, along with a clear and concise statement summarizing support received. Disbursements for support provided as One-Timer and Run It Back are automatically disbursed by the software on the 15^{th} day of the month following the date on which the payment was processed.

Disbursements for Stick Around and Fresh Start support are disbursed as follows. For the Stick Around support, if the Student-Athlete returns to the same school and participates in the same sport as he did in the previous academic year, then all of the Student-Athlete's Stick Around support payments are disbursed to the Student-Athlete within six months of the start of the sports season for which the Stick Around support payments were made. Verification that the Student-Athlete has returned to the same school and is participating in the same sport will be verified by 1) Verifying enrollment at the school for the then current term; and 2) Verifying that the Student-Athlete is on the school's roster for the same sport for which he received the Stick Around support.

For the Fresh Start support, if a Student-Athlete transfers to a different school and participates in the same sport as he did in the previous academic year, then the Student-Athlete receives the Fresh Start support funds correlating to the transferred to school (i.e. If there is $50,000.00 in Fresh Start support for School A, and $100,000.00 in Fresh Start support for School B, and the Student-Athlete selects School A, the Student-Athlete will receive only $50,000.00 in Fresh Start support) on a prorated basis.

Before Fresh Start support is disbursed, the invention verifies transfer to and participation in the same sport at the new school by 1) Verifying enrollment at the school for the then current term; and 2) Verifying that the Student-Athlete is on the school's roster for the same sport for which he received the Fresh Start support.

Once verification is accomplished, disbursement of Fresh Start support payments will be prorated over the course of a Student-Athlete's remaining eligibility, as determined by the first academic year of participation in college sports provided by the Student-Athlete during the registration process. Proration occurs using the following steps. 1. Assign a value of 1 to the Student-Athlete's first academic year of participation in college sports; 2. Assign a value of 2 to the academic year following the Student-Athlete's first academic year of participation in college sports; 3. Assign a value of 3 to the academic year which is 2 years following the Student-Athlete's first academic year of participation in college sports; 4. Assign a value of 4 to the academic year which is 3 years following the Student-Athlete's first academic year of participation in college sports; 5. Subtract the numeric value assigned for the academic year in which the Fresh Start support was made from 5; 6. Divide the total of the Fresh Start support payments received by the Student-Athlete by the result obtained in step 5; and 7. Disburse the result obtained in step 6 to the Student-Athlete within six months of the start of the sports season for which the Fresh Start support payments were made, and within six months of the start of the sports season in each subsequent year, provided that the Student-Athlete remains at the same school in the subsequent year(s) (and once verification is accomplished for such year, as described above), until all Fresh Start support payments have been disbursed.

If a Student-Athlete is granted eligibility to participate in college sports in excess of 5 years due to multiple injuries or other unforeseen circumstances, the invention administrators will manually adjust the numeric values described above accordingly.

If a Student-Athlete transfers to a different school prior to disbursement of all Fresh Start support payments, the Student-Athlete forfeits all such undisbursed Fresh Start support payments, and the support payments are refunded to the Supporters.

Having described above the Supporter experience, funding module, and his various functions, let us turn to more detail in the rewards as at 107. Every form of support involves Tiered Rewards and Tracking as at 111. The invention incentivizes Supporters to further engage with his chosen Student-Athletes by offering tiered levels of rewards, and all support accumulated, as at 112, over time by a Supporter to a Student-Athlete is tracked within the invention and is credited towards achievement of tiered rewards. The tiers begin at the Bronze level where Every Supporter who supports a Student-Athlete earns a Bronze Medal, and receives the Thank You Video 19 recorded by the Student-Athlete during registration. Supporters then may earn Silver, Gold and Platinum Medals, depending on his level of support in the following ways.

For a Silver Medal, a Supporter receives a “Personalized Thank You Video.” A “Personalized Thank You Video” is a video recorded by the Student-Athlete in which the Student-Athlete expresses gratitude for support and personally identifies the Supporter, and which is sent only to that particular Supporter. The amount of support necessary for a Supporter to achieve a Silver Medal varies by Student-Athlete, and is determined by the Student-Athlete during initial registration, as described above as at Process x02.

The Student-Athlete, at the Student-Athlete's discretion, can modify the amount of support necessary to achieve a Silver Medal at any time by as at Process x06:
1. The Student-Athlete logs into the invention;
2. The Student-Athlete selects “Rewards” from a menu located near the bottom of any page of the platform;
3. The Student-Athlete selects “Silver Medal” from the options on the screen;
4. The Student-Athlete taps the field with the “$” on the page and uses the automatically generated keypad to enter the total support required for a Supporter to earn a Silver Medal; and
5. The Student-Athlete taps the “Save” button near the bottom of the page.

Once a Supporter earns a Silver Medal (either with the current payment alone or cumulatively), the Supporter receives in-app and e-mail notifications that the Supporter has achieved Silver Medal status for the supported Student-Athlete, and the supported Student-Athlete receives in-app and e-mail notifications that the required support has been made and that the Student-Athlete needs to prepare and send a Personalized Thank You Video to the Supporter. The earned Silver Medal also appears in the Rewards Fulfillment section of the Student-Athlete's “Rewards” page in the invention platform until the reward is fulfilled. The process for fulfilling a Personalized Thank You Video as at Process x03 is that from the Student-Athlete's notification, the Student-Athlete taps the “Record personalized video here” link. The invention then opens the Student-Athlete's native camera app on his mobile device and prompts him to begin recording. The Student-Athlete then records a video of himself offering gratitude, identifying the Silver Medal earning Supporter by name, for the support using his mobile device. The Student-Athlete then taps Finish and the Personalized Thank You Video is automatically sent to the Silver Medal earning Supporter by the invention.

For a Gold Medal, a Supporter receives a “Social Media Shoutout” in which the Student-Athlete expresses gratitude for support by personally identifying the Supporter (using preferred information provided by the Supporter) in a social media post, on a social media platform on which the Student-Athlete has an account and is selected by the Supporter. The amount of support necessary for a Supporter to achieve a Gold Medal varies by Student-Athlete, and is determined by the Student-Athlete during initial registration as at Process x02. The Student-Athlete, at the Student-Athlete's discretion, can modify the amount of support necessary to achieve a Gold Medal at any time by using the following process as at Process x07:
1. The Student-Athlete logs into the invention;
2. The Student-Athlete selects “Rewards” from a menu located near the bottom of any page of the invention;
3. The Student-Athlete selects “Gold Medal” from the options on the screen;
4. The Student-Athlete taps the field with the “$” on the page and uses the automatically generated keypad to enter the total support required for a Supporter to earn a Gold Medal; and
5. The Student-Athlete taps the “Save” button near the bottom of the page.

Once a Supporter earns a Gold Medal, such as either with the current payment alone or cumulatively, the Supporter automatically receives, via the invention platform, in app pop-up and e-mail notifications prompting him to provide necessary information to the Student-Athlete for fulfillment of the Social Media Shoutout, including the Supporter's preferred social media platform and social media handle. Once the information is provided, the supported Student-Athlete receives in-app and e-mail notifications that the required support has been made and that the Student-Athlete needs to prepare and post a Social Media Shoutout to the Supporter. The earned Gold Medal also appears in the Rewards Fulfillment section of the Student-Athlete's “Rewards” page in the invention platform until the reward is fulfilled. The process as at Process x04 for fulfilling a Social Media Shoutout follows:
1. Once the threshold for achieving Gold Medal status for the Student-Athlete is achieved, the Supporter received in-app and e-mail notifications that he has achieved a Gold Medal, and is prompted in the notification to provide information necessary for fulfillment of the Social Media Shoutout;
2. The Supporter, on the notification, is provided:
a. A drop-down menu of the social media platforms on which the Student-Athlete participates, from which the Supporter selects which social media platform he prefers the post to appear on; and
b. An empty field in which to enter the Supporter's preferred identifying information (i.e., the Supporter's handle on the social media platform, or the Supporter's name) to be used in the Social Media Shoutout.
3. The Supporter taps the “Done” button on the screen.
4. A notification is then sent to the Student-Athlete by the invention, via the app and via e-mail, that the Supporter has achieved Gold Medal status, and that the Student-Athlete needs to prepare and post a Social Media Shoutout. Included in the notification is the Supporter's preferred social media platform and handle or name.

For a Platinum Medal, a Supporter receives a “Personalized Autographed Memorabilia Item.” A Personalized Autographed Memorabilia Item is memorabilia specific to the sport or activity that the Student-Athlete participates in (i.e.. a football, football helmet, mini football helmet, baseball, basketball, volleyball, or hockey puck) which is personally autographed by the Student-Athlete and dedicated to the Supporter or another person chosen by the Supporter. A Personalized Autographed Memorabilia Item is distinguishable from other commonly available autographed memorabilia because it is unique to the Supporter. For example, if a Supporter named John achieves Platinum Medal status with a football player named Tom Campbell, John could request a personalized inscription such as “To John, a great fan, (signed) Tom Campbell,” and Tom Campbell would sign a football or football helmet as such.

The amount of support necessary for a Supporter to achieve a Platinum Medal varies by Student-Athlete, and is determined by the Student-Athlete during initial registration, as described above as at Process x02, but subject to minimum thresholds that are set by the invention administrators from time to time. The Student-Athlete, at the Student-Athlete's discretion, can modify the amount of support necessary to achieve a Platinum Medal at any time by using the following process as at Process x08:
1. The Student-Athlete logs into the invention;
2. The Student-Athlete selects “Rewards” from a menu located near the bottom of any page of the platform;
3. The Student-Athlete selects “Platinum Medal” from the options on the screen;
4. The Student-Athlete taps the field with the “$” on the page and uses the automatically generated keypad to enter the total support required for a Supporter to earn a Platinum Medal; and
5. The Student-Athlete taps the “Save” button near the bottom of the page. Once a Supporter earns a Platinum Medal (either with the current payment alone or cumulatively), the Supporter and the Student-Athlete receive in-app and e-mail notifications that the Supporter has achieved Platinum Medal status for the supported Student-Athlete. The Supporter, through the invention, then provides necessary information for personalization and delivery of the Personalized Autographed Memorabilia Item, and the invention, through its automated processes, facilitates production and delivery of the Personalized Autographed Memorabilia Item to the Supporter. The earned Platinum Medal also appears in the Rewards Fulfillment section of the Student-Athlete's “Rewards” page in the invention until the reward is fulfilled. The process as at Process x05 for fulfilling a Personalized Autographed Memorabilia Item is as follows:
1. Once the threshold for achieving Platinum Medal status for the Student-Athlete is achieved, the Supporter received in-app and e-mail notifications that he has achieved a Platinum Medal, and is prompted in the notification to provide information necessary for fulfillment of the Personalized Autographed Memorabilia Item;
2. The Supporter confirms or provides a shipping address for the Personalized Autographed Memorabilia Item from the notification pop-up in the mobile app or web app. To do so, a drop-down menu of addresses in the Supporter's profile is automatically generated. The Supporter can select one of the addresses that are automatically populated, or can add a new shipping address by tapping the “Edit” button above the drop-down menu;
3. The Supporter enters his requested inscription for the Personalized Autographed Memorabilia Item from the notification pop-up in the mobile or web app. To do so, the Supporter simply taps on the text field below a message that indicates to the Supporter that he should enter the text of the custom inscription and types the message (i.e.. “To John, a great fan, (signed) Tom Campbell”);
4. The Supporter taps the “Done” button on the page/pop-up;
5. A message is automatically sent to the invention's administrators via the invention, notifying the invention's administrators that the Supporter has reached Platinum Medal status for the supported Athlete and that the Supporter has provided the information necessary to fulfill the Personalized Autographed Memorabilia Item;
6. Invention administrators prepare a package to be sent to the supported Student-Athlete which includes:
   a. The memorabilia item to be personally signed by the Student-Athlete;
   b. A permanent marker for the Student-Athlete to use to sign the Personalized Autographed Memorabilia Item;
   c. An instruction sheet, including the inscription requested by the Supporter on the Personalized Autographed Memorabilia Item, and packing and shipping instructions for delivery of the Personalized Autographed Memorabilia Item to the Supporter;
   d. Packaging tape for the Student-Athlete to use to reseal the package to be sent to the Supporter; and
   e. A pre-paid shipping label for the Student-Athlete to affix to the package to be sent to the Supporter.
7. The Student-Athlete autographs the item per the provided instructions, packages it, and delivers the package containing the signed Personalized Autographed Memorabilia Item to a drop-off location for the shipping service specified by the invention administrators in the instructions.

The Supporter experience 101 through the reward function 107 tracks rewards for Supporters as at 112. The invention tracks all support payments made by Supporters to Student-Athletes. As Supporters provide support over time, they become eligible for tiered levels of rewards based on their cumulative contributions.

Supporters can easily monitor their current reward status and progress towards reaching the next tiered reward through the intuitive “Rewards” section of their profile as part of the Supporter experience 101. This dedicated area provides a comprehensive overview of the Supporter's support history and reward eligibility.

Upon entering the “Rewards” section as at 107, the invention presents Supporters with options to view their status for Silver, Gold, and Platinum Medals. For each rewards level, miniaturized profile pictures of some of the supported Student-Athletes in that tier appear. Selecting any of the reward tiers displays a complete list of Student-Athletes for whom the Supporter has achieved that particular level of recognition.

For each Student-Athlete displayed under the chosen reward tier, the invention prominently showcases:
1. The additional support required to reach the next reward level for that specific Student-Athlete;
2. A visual indicator (a status bar that fills, demonstrating progress) showing the Supporter's progress towards the next reward threshold; and
3. A “Support Now” button, which if tapped by the Supporter seamlessly navigates him to the Support section of the Student-Athlete's Public Facing Profile, and the Supporter can further support the Student-Athlete using the processes described herein, thereby contributing to the Supporter's progress towards earning the next tiered reward level.

Through this user-friendly interface, the invention empowers Supporters to visualize their progress effortlessly and transparently towards earning additional rewards, and continue supporting their favorite Student-Athletes to earn those additional rewards with ease.

As identified briefly above, Referral Codes as at 22 play a role for the Student-Athletes and the Supporters as they use the invention and the administrators as they operate the invention. The invention utilized a Referral Code system, see generally 22, to enhance Supporter and Student-Athlete engagement by enabling and rewarding the referral of others to the invention. The Referral Code system incorporates a rewards mechanism where Supporters and Student-Athletes can earn points, rewards, digital content, discounts, or special access to events and promotional sweepstakes for successful referrals.

Upon registration and creation of an account within the invention as at 100 and 10 respectively, all Supporters and Student-Athletes are automatically assigned a unique referral code. The referral code is system-generated to ensure universality and prevent duplication.

The invention's administrative panel, within the management module 200, shall incorporate tracking mechanisms to monitor and accurately attribute referrals to the corresponding referring Supporter or Student-Athlete. The tracking process shall ensure proper allocation of rewards based on successful referrals, in accordance with predetermined reward systems established by the invention.

From a Supporter's Account page as at 105, the Supporter quickly disseminates his unique referral codes through various channels. Supporters can easily share their referral codes by tapping on the prominent “SMS” (for sharing via text message) or “Email” (for sharing using their email account) buttons below their referral code, or by copying the referral code (by simply tapping the “Copy” button next to the referral code on the page) and pasting it into any electronic communications platform, including social media websites and applications. Likewise, Student-Athletes enjoy the same functionality from their Account pages.

When a new user utilizes a shared referral code to successfully register for the invention, the referring Supporter or Student-Athlete is notified of the successful referral.

Such notifications shall be delivered through multiple channels, including in-app notifications within the invention, push notifications for mobile device users, and email notifications.

Upon a successful referral, the referring Supporter or Student-Athlete is eligible to receive the corresponding reward as determined by the invention's Referral Code reward system. These rewards may include, but are not limited to, points, digital content, discounts, or special access to events and promotional sweepstakes, as defined by the specific terms and conditions of the reward program.

Within the Supporter experience 101 and inside of the Supporter's payments 106, the invention has “Head-to-Head Matchups” as at 108. Head-to-Head Matchups are select high-profile competitions such as rivalry, playoff, and championship games, and they pit Supporters of competing schools against one another in a contest to see which set of Supporters can accumulate the most support for their school within a prescribed period of time leading up to and during the competition.

The process for a Supporter to make a support payment in a Head-to-Head Matchup includes:
1. Locate the Head-to-Head Matchup on the Invention. There are multiple methods on the invention for a Supporter to find a Head-to-Head Matchup:
   a. The invention notifies, in app and via e-mail, Supporters who have indicated that a school is one of their favorites during Supporter Registration 100 and as updated on the Supporter's ‘Favorites’ Page 104, and Supporters of one or more Student-Athletes at a particular school, when a Head-to-Head Matchup involves that school. From the Notification, the Supporter simply taps the “Support Your Favorite Team Now” button. The Supporter then proceeds as described in Step 2, below. or
   b. All Head-to-Head Matchups are automatically populated in the Head-to-Head Matchups portion of the Find Athletes section of the Supporter's Home page when a Head-to-Head Matchup involves a school which the Supporter has indicated as a favorite, or the Supporter has supported one or more Student-Athletes from the school in the past. From the Head-to-Head Matchups portion of the Find Athletes section of the Supporter's Home page, the Supporter simply clicks on the Head-to-Head Matchup the Supporter is interested in and proceeds as described in Step 2, below. or
   c. From the Find Athletes section of Supporter's Home page, tap on the Head-to-Head Matchups button, which seamlessly navigates the Supporter to the Head-to-Head Matchups page. From the Head-to-Head Matchups page, the Supporter taps on the Head-to-Head Matchup they're interested in and proceeds as described in Step 2, below.
And,
2. The Supporter, utilizing one of the methods described above, is now on the Head-to-Head Matchup page for the competition the Supporter is interested in. The Head-to-Head Matchup page contains the logos and names of the schools participating in the Head-to-Head Matchup, and next to each logo is a “Support Now” button. Then, the invention guides the Supporter as follows:
   a. The Supporter taps on Support Now button next to the school they wish to support in the Head-to-Head Matchup and a pop-up is generated with two items: a text entry field containing a “$,” and a drop-down menu;
   b. The Supporter enters the amount that they want to support in the text entry field containing a “$;”
   c. The drop-down menu contains two selections: “Support the Current Team” and “Future Roster Support.” The Supporter chooses the option they prefer and taps the “Done” button on the screen; and d. The Supporter proceeds with payment by applying funds from the Supporter's wallet, or entering payment information, using the invention's secure web payment system.

Supporter funds generated from Head-to-Head Matchups are deposited into a separate Head-to-Head Matchup account maintained by invention administrators. Once a Supporter makes a Head-to-Head Matchup support payment, the Supporter immediately receives in-app and e-mail notifications, confirming the details of the transaction. The Supporter also immediately receives Thank You Videos via in-app notification, as well as an e-mail containing links to the gated Thank You Videos as at 19a. The Thank You Videos sent are from the Student-Athletes who are on the roster of the team participating in the Head-to-Head Matchup supported by the Supporter, and who are registered to participate in the invention (“Head-to-Head Supported Athletes”).

If the Supporter selects the Support Current Team option during the above process, distribution of funds to Student-Athletes for Head-to-Head Matchups is conducted in an equitable manner. All Head-to-Head Supported Athletes receive equal shares of the support received, irrespective of individual performance or any other factors. Once the Head-to-Head Matchup is complete, regardless of the outcome, the support generated for each school (after deduction of fees) is divided evenly amongst the school's Head-to-Head Supported Athletes, and automatically disbursed by the invention to such Head-to-Head Supported Athletes on the 1₅ₜh day of the month following the date on which the Head-to-Head Matchup occurred.

If the Supporter selects the Future Roster Support option during the above process, then once the Head-to-Head Matchup is complete, regardless of the outcome, the support generated for each school (after deduction of fees) is delivered to the supported school's NIL collective or athletic department, as agreed upon by the school and invention administrators. The funds are automatically disbursed by the invention's software to such organization on the 15^{th} day of the month following the date on which the Head-to-Head Matchup occurred.

Through this process, the Head-to-Head Matchup feature on the invention platform fosters engagement and friendly competition between groups of Supporters, while simultaneously generating financial support for the Student-Athletes involved in the high-profile events, or future support for Student-Athletes of the schools involved.

Also as part of the invention it has a Highlights Curated Video Page which has curated videos from all participating Student-Athletes on the invention. This page serves as a centralized hub for Supporters to discover and engage with Student-Athlete content.

Student-Athletes have the ability to record videos up to 90 seconds in length through the invention's interface. Such videos are stored within the Student-Athlete's profile as at 19 and simultaneously displayed on the curated video page for Supporter discovery as at 101.

The invention employs a sophisticated algorithm for video delivery on the curated page. This algorithm prioritizes videos from Student-Athletes marked as favorites by the Supporter, while also introducing videos from other Student-Athletes to broaden the Supporter's exposure to potential new favorites. The algorithm is designed to balance familiarity with discovery, enhancing the Supporter experience and potential for new Student-Athlete support connections.

The curated video page is accessible via a dedicated button in the bottom navigation menu of the invention. Supporters must actively navigate to this page to view the curated video content, ensuring that engagement with this feature is intentional and user driven.

The curated video page incorporates functionality for Supporters to interact with the content in limited ways:
a. Like Button: Supporters can express appreciation for a video by utilizing a ‘like’ button associated with each video; and
b. Share Function: The invention allows Supporters to share videos across various social media platforms or via text messages, all within the confines of the invention. This feature facilitates broader exposure for Student-Athletes while keeping Supporters within the ecosystem of invention users.

To maintain a focused user experience and protect Student-Athletes, the curated video page does not include features for Supporter comments or direct interaction with the featured Student-Athletes on the video feed itself. This curated video feature is designed to enhance Supporter engagement with the invention platform, facilitate the discovery of new Student-Athletes, and provide Student-Athletes with an additional avenue for visibility within the application. The feature adheres to the invention's overall mission of connecting Supporters with Student-Athletes while maintaining appropriate boundaries and Supporter experience quality. Through this feature, the invention continues to innovate in the NIL space, providing unique opportunities for Supporter engagement and Student-Athlete exposure, all while maintaining the integrity and security of the invention.

Though the above description has referred to Student Athletes, such athletes do not hold membership or employment in a professional sports league. Thus Student Athletes may also have the honorable appellation of amateur. The above description describes the Student Athlete and Supporter by their roles and relationship promoted by the invention. The invention operates as a method upon computer coding or programming.

Thus, a Student Athlete may also be a first user while a Supporter may be a second user.

The invention takes another form of a method to promote interaction between a Student-Athlete and a Supporter using the name, the image, and the likeness of the Student-Athlete. This method for interaction has registration of at least one Student-Athlete, registration of at least one Supporter, sharing the nondownloadable name, image, and likeness of the Student-Athlete with the Supporter after the Supporter pays funds into the invention. The invention tracks the payment of funds and operates a rewards system for the Student-Athlete. It also operates a rewards system for the Supporter. This form of the invention then provides a Student-Athlete experience including an athlete profile, a support page, an earnings page, and a rewards page. It next provides the Student-Athlete profile with an overview page, a dashboard, a photos page, a videos page, and a support page. This form of the invention next has a Supporter experience including a favorites page, an account page, a payments page, a homepage, a dashboard, and a rewards page. Here the providing the Supporter dashboard has a videos page that has communication with the video page of the Student-Athlete. This method later provides its displaying a public facing profile that shows data from the student-athlete. Lastly to overcome student procrastination, this form of the invention prompts the Student-Athlete to record a Thank You Video promptly upon the operation of the Supporter rewards system indicating said tracking payment of funds having received funds.

The invention takes another alternate form of mutual digital communication between two classes of users being subject to strict regulatory limits. Those classes of users have these definitions: one class of users as Student-Athlete and the other class of users as Supporter. This form of the invention prompts the Student-Athlete to record communications to a Supporter upon certain events. This form of the invention next prompts the Supporter to donate to Student-Athlete upon receipt of communications from the Student-Athlete following certain events. And this form of the invention tracks financial activity from a Supporter to the proper Student-Athlete within regulatory limits.

The alternate form of the invention then has its defining one class of users as Student-Athlete compare identification information of a Student-Athlete and digital information of a Student-Athlete against secondary school and collegiate school enrollment. It also has its defining the other class of users as Supporter comparing identification information of a Supporter for a minimum age of eighteen. Next, this alternate form defines the certain events of the Student-Athlete as enrollment at one or secondary school and collegiate school, attendance at first day of training for a season, attendance at first varsity event, participation in first varsity event ever for Student-Athlete, participation in first varsity event of a season for Student-Athlete, breaking of Student-Athlete's record while on the varsity, Student-Athlete breaking a record of the varsity team, Student-Athlete breaking a record of a conference for varsity team while on the varsity, Student-Athlete breaking a record of a playoff for varsity team while on the varsity, Student-Athlete breaking a record of a tournament for varsity team while on the varsity, Student-Athlete breaking a world record, Student-Athlete breaking an Olympic record, and Student-Athlete making dean's list while on the varsity. Though this list of events is provided, the Applicants foresee other events suitable as milestones and other key moments for a Student-Athlete preseason, in season, and in post season. The Applicants also foresee events selected by the Supporter and the Student-Athlete by mutual agreement. Then the invention once more tackles procrastination as it prompts the Student-Athlete to record communications to Supporter upon certain events including comparing a performance of Student-Athlete against databases of varsity records, world records, and Olympic records wherein upon detecting the performance of Student-Athlete exceeding one of said records, said prompting Student-Athlete to record communications to Supporter sends a digital message to a portable electronic device selected by the Student-Athlete wherein the Student-Athlete records one of a written message, an audio message, a video message, and a video with audio message within a defined time period. This alternate form of the invention then has a prompt for the Supporter to donate to Student-Athlete upon receipt of communications from the Student-Athlete following certain events. The Supporter donation step, or module then authenticates a communication from the Student-Athlete where it states the certain event that occurred, reminds the Supporter of any selected donation amount, guides the Supporter to complete the donation. Lastly, this alternate form of the invention has its tracking financial activity from a Supporter to the proper Student-Athlete within regulatory limits. This Supporter tracking has authenticating a donation from the Supporter as financially sound, summarizing the donation from the Supporter, the certain event, and the communication from the Student-Athlete, comparing the certain event to the communication from the Student-Athlete for a match between the two, depositing the donation from the Supporter into an account of the Student-Athlete, and within the regulatory limits of the NCAA, Federal Reserve, and the Department of the Treasury.

The invention takes another alternate form of promoting communication between a Student-Athlete and a Supporter using the name, the image, and the likeness of the Student-Athlete. This form of the invention provides a management module that operates this form, initiates communication to the Student-Athlete and collects communication from the Student-Athlete, delivers communication to the Supporter and collects communication from the Supporter, and tracks financial transactions from the Supporter into the invention and onward to the Student-Athlete. It also has a registration module that collects information upon the Student-Athlete and that collects information upon the Supporter for use. It then has a user experience module that displays communication from the Student-Athlete to the Supporter upon certain events and that displays corresponding communication from the Supporter to the Student-Athlete. And this form of the invention operates within strict regulatory limits. This form of the invention has its user experience module that displays a name, an image, and a likeness of the Student-Athlete to the Student-Athlete and to the Supporter, and tracks financial transactions from the Supporter into the invention and from the invention out to the Student-Athlete upon selected events of the Student-Athlete. The selected events include an academic milestone at one of secondary school and collegiate school, a preseason milestone, attending a first event for a season, participating in a first event for a season, breaking of a record during the season, and participating in an event after the season, and events the Applicants foresee. The providing a user experience module also compares a performance of Student-Athlete against databases of records and upon detecting the performance of Student-Athlete exceeding a record, it prompts the Student-Athlete to communicate to a Supporter using a digital message sent to a portable electronic device previously selected by the Student-Athlete. Using that device, the Student-Athlete records one of a written message, an audio message, a video message, and a video with audio message within a defined time period. Of course, this form of the invention has the user experience module track financial transactions from a Supporter to the proper Student-Athlete within regulatory limits. That tracking involves authenticating a donation from the Supporter as financially sound, summarizing the donation from the Supporter, the selected event, and the communication from the Student-Athlete, comparing the selected event to the communication from the Student-Athlete for a match between the two, depositing the donation from the Supporter into an account of the Student-Athlete, and this form of the invention operates within the regulatory limits of the NCAA, Federal Reserve, the Department of the Treasury, and others.

While a preferred embodiment of the method to promote interaction between athletes and fans has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Although providing a method to promote interaction between athletes and fans has been described, it should be appreciated that the invention herein described is also suitable for a wide variety of sports at the high school level and up within the limits proscribed by regulatory bodies.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations have been set forth in order to provide a thorough understanding of the illustrative embodiments.

However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods, and systems for carrying out the several purposes of the present invention. Therefore, the claims include such equivalent constructions insofar as they do not depart from the spirit and the scope of the present invention.

We claim:

1. A method to promote interaction between a Student-Athlete and a Supporter using the name, the image, and the likeness of the Student-Athlete, comprising:
registering at least one Student-Athlete;
registering at least one Supporter;
sharing nondownloadable name, image, and likeness of the Student-Athlete with the Supporter upon payment of funds;
tracking the payment of funds;
operating a rewards system for the Student-Athlete; and
operating a rewards system for the Supporter.

2. The method to promote interaction between a Student-Athlete and a Supporter of claim 1 further comprising:
providing a Student-Athlete experience including an athlete profile, a support page, an earnings page, and a rewards page;
providing said Student-Athlete profile with an overview page, a dashboard, a photos page, a videos page, and a support page;
providing a Supporter experience including a favorites page, an account page, a payments page, a homepage, a dashboard, and a rewards page; and
providing said Supporter a dashboard with a videos page, said video page of said Supporter having communication with said video page of said athlete.

3. The method to promote interaction between a Student-Athlete and a Supporter of claim 2 further comprising:
displaying a public facing profile is adapted to show data from the student-athlete; and
prompting the Student-Athlete to record a Thank You Video promptly upon said operating the Supporter rewards system indicating said tracking payment of funds having received funds.

4. A method for mutual digital communication between two classes of users, said method for mutual digital communication being subject to strict regulatory limits, comprising:
defining one class of users as Student-Athlete;
defining the other class of users as Supporter;
prompting Student-Athlete to record communications to Supporter upon certain events;
prompting Supporter to donate to Student-Athlete upon receipt of communications from the Student-Athlete following certain events; and
tracking financial activity from a Supporter to the proper Student-Athlete within regulatory limits.

5. The method for mutual digital communication between two classes of users of claim 4, further comprising:
said defining one class of users as Student-Athlete comparing identification information of a Student-Athlete and digital information of a Student-Athlete against secondary school and collegiate school enrollment;
said defining the other class of users as Supporter comparing identification information of a Supporter for a minimum age of eighteen;
defining the certain events of the Student-Athlete as enrollment at one or secondary school and collegiate school, attendance at first day of training for a season, attendance at first varsity event, participation in first varsity event ever for Student-Athlete, participation in first varsity event of a season for Student-Athlete, breaking of Student-Athlete's record while on the varsity, Student-Athlete breaking a record of the varsity team, Student-Athlete breaking a record of a conference for varsity team while on the varsity, Student-Athlete breaking a record of a playoff for varsity team while on the varsity, Student-Athlete breaking a record of a tournament for varsity team while on the varsity, Student-Athlete breaking a world record, Student-Athlete breaking an Olympic record, and Student-Athlete making dean's list while on the varsity; and
said prompting Student-Athlete to record communications to Supporter upon certain events including comparing a performance of Student-Athlete against databases of varsity records, world records, and Olympic records wherein upon detecting the performance of Student-Athlete exceeding one of said records, said prompting Student-Athlete to record communications to Supporter sends a digital message to a portable electronic device selected by the Student-Athlete wherein the Student-Athlete records one of a written message, an audio message, a video message, and a video with audio message within a defined time period.

6. The method for mutual digital communication between two classes of users of claim 5, further comprising:
said prompting Supporter to donate to Student-Athlete upon receipt of communications from the Student-Athlete following certain events including:
authenticating a communication from the Student-Athlete;
stating the certain event that occurred;
reminding the Supporter of any selected donation amount; and
guiding the Supporter to complete the donation.

7. The method for mutual digital communication between two classes of users of claim 6, further comprising:
said tracking financial activity from a Supporter to the proper Student-Athlete within regulatory limits including:
authenticating a donation from the Supporter as financially sound;
summarizing the donation from the Supporter, the certain event, and the communication from the Student-Athlete;
comparing the certain event to the communication from the Student-Athlete for a match between the two;
depositing the donation from the Supporter into an account of the Student-Athlete; and
wherein the regulatory limits include at least one of the NCAA, the Federal Reserve, and the Department of the Treasury.

8. A method to promote communication between a Student-Athlete and a Supporter using the name, the image, and the likeness of the Student-Athlete, comprising:
providing a management module, said management module operating said method, initiating communication to the Student-Athlete and collecting communication from the Student-Athlete, delivering communication to the Supporter and collecting communication from the supporter, and tracking financial transactions from the Supporter into said method and onward to the Student-Athlete;
providing a registration module that collects information upon the Student-Athlete and the collects information upon the Supporter for use by the method; and
providing a user experience module that displays communication from the Student-Athlete to the Supporter upon certain events and that displays corresponding communication from the Supporter to the Student-Athlete;
where said method is adapted to operate within strict regulatory limits.

9. The method to promote communication between a Student-Athlete and a Supporter of claim 8, comprising:
said providing a user experience module including displaying a name, an image, and a likeness of the Student-Athlete to the Student-Athlete and to the Supporter, and tracking financial transactions from the Supporter into said method and from said method out to the Student-Athlete upon selected events of the Student-Athlete;
said selected events further comprising enrollment an academic milestone at one of secondary school and collegiate school, a preseason milestone, attending a first event for a season, participating in a first event for a season, breaking of a record during the season, and participating in an event after the season; and
said providing a user experience module including comparing a performance of Student-Athlete against databases of records and upon detecting the performance of Student-Athlete exceeding one of said records, said providing a user experience module prompting the Student-Athlete to communicate to a Supporter using a digital message sent to a portable electronic device selected by the Student-Athlete;
wherein the Student-Athlete records one of a written message, an audio message, a video message, and a video with audio message within a defined time period.

10. The method to promote communication between a Student-Athlete and a Supporter of claim 9, comprising:
said providing a user experience module having tracking financial transactions further comprising tracking financial activity from a Supporter to the proper Student-Athlete within regulatory limits;
said tracking financial transactions further comprising:
authenticating a donation from the Supporter as financially sound;
summarizing the donation from the Supporter, the selected event, and the communication from the Student-Athlete;
comparing the selected event to the communication from the Student-Athlete for a match between the two;
depositing the donation from the Supporter into an account of the Student-Athlete; and
wherein the regulatory limits include at least one of the NCAA, the Federal Reserve, and the Department of the Treasury.
